(19) United States
(12) Patent Application Publication
(10) Pub. No.: US 2024/0239013 A1
(43) Pub. Date: Jul. 18, 2024

(54) SYSTEM AND METHOD FOR PLACING AND CIRCULATING CONCRETE

(71) Applicant: STEELIKE, INC., Springfield, VA (US)

(72) Inventors: William Thomas KULISH, Fairfax, VA (US); Timothy ROSS, Kannapolis, NC (US)

(73) Assignee: STEELIKE, INC., Springfield, VA (US)

(21) Appl. No.: 18/564,545

(22) PCT Filed: May 10, 2022
(86) PCT No.: PCT/US2022/028561

§ 371 Date: Nov. 27, 2023

Related U.S. Application Data
(60) Provisional application No. 63/194,269, filed on May 28, 2021.

(51) Int. Cl. B28C 5/14; B28C 5/46; B28C 7/16

(52) U.S. Cl. CPC B28C 5/142; B28C 5/468; B28C 7/163

(57) ABSTRACT

A system and method for placing and circulating concrete is disclosed. The system includes a hopper body, a feed auger, one or more circulating elements, a pump, a valve with two or more outlets, a return conduit, and two or more hoses. The hopper body of the system may additionally include a heat exchanger. Concrete slurry is placed into the hopper body, continuously circulated within the hopper body, and drawn from the hopper body by the pump and conveyed through the hoses, or through the return conduit, or both. Concrete slurry within the hoses may be returned to the hopper body.

### FIELD OF THE DISCLOSURE

The present disclosure generally relates to placement and circulation of concrete for constructing roadways and other infrastructure, and more specifically, the present disclosure relates to a system for faster and more efficient placement and circulation of ultra-high performance concrete.

### BACKGROUND OF THE DISCLOSURE

Enormous amounts of concrete are used every year to construct roads, bridges, buildings and other infrastructure. Concrete is typically made from a blend of dry ingredients, which are mixed with water and/or other fluids to create a slurry. The slurry is then placed and allowed to set to form hardened concrete. The slurry can be placed into a form or mold for creating a specific element offsite from the construction site so that, after the concrete has set, the element can be removed from the form and then transported to a desired location at the construction site for immediate use. The slurry can also be placed into a form or mold, or used without a form or mold, directly at its final location at the construction site, where it sets in place. In the latter case, if forms or molds are used, they are removed after the concrete has set.

There are existing approaches to mixing concrete into slurry, including hoppers housing a single auger and concrete mixer trucks (collectively “mixers”). Upon creating the slurry in a mixer, the slurry is then typically placed directly from the mixer into a form or final site location. The slurry can be placed by directing the flow of the slurry from the mixer directly into the form or site location, and is sometimes conveyed from the mixer to the form or site location through a pipe, hose or other conduit, or on a conveyor.

Concrete slurries have varying dwell times. Dwell time refers to the period of time between mixing the concrete into a slurry and when the concrete begins to harden and becomes too viscous to place. Some concrete slurries harden quicker than others, depending on the formulation. Typically, concrete slurries with lower percentages of water have shorter dwell times. The dwell time has to be taken into account when mixing and placing any particular concrete. If too much time is spent between mixing the concrete into a slurry and placing it, the concrete can thicken up or harden and become unusable. Consequently, concrete is typically mixed and placed in batches. For larger jobs requiring a lot of concrete, this can require a significant amount of labor, mixing and placing equipment, and planning to ensure that the concrete slurry is mixed just in time and then placed before it is too late. Among other things, each mixer oftentimes needs to be cleaned between each batch. Additionally, when multiple mixers are used, they need to be carefully coordinated to circulate them in for placing the concrete at just the right time, also ensuring that the dwell time in any individual mixer is not too long. As a consequence of these and other factors, the time and labor required at a construction site to mix and place can be significant. The costs for such time and labor can contribute significantly to the overall cost for the construction job, well beyond the cost of the concrete material itself.

Certain concretes, like high-performance concrete (“HPC”) and ultra-high performance concrete (“UHPC”) have very short dwell times. Among other things, HPC and UHPC have lower percentages of water leading to shorter dwell times. In some cases, HPC and UHPC materials undergo exothermic reactions when the dry ingredients are mixed with water and/or other fluids, which aides hardening but further decreases dwell time. Additionally, HPC and UHPC materials harden more quickly in warmer temperatures than cooler ones, as may be encountered during summer months or regionally in any month. This can make the logistics of mixing and placing HPC and UHPC at a job site even more challenging.

Additionally, current placement techniques for UHPC to repair structure on the underside of bridges include cutting openings into the deck of the bridge and using gravity to feed UHPC through the openings to the underside of the deck. After the UHPC is placed, the deck must be repaired. Cutting and repairing openings in the bridge deck can cost significant amounts of time and money.

An object of the inventions disclosed herein is to make it easier, more efficient, and less costly to place concrete. A further object of the inventions disclosed herein is to enable concrete, and particularly HPC and UHPC, to be placed at a construction site in a more continuous fashion. An even further object of the inventions disclosed herein is to increase the dwell time for concrete slurry and, in particularly HPC and UHPC slurries. Yet an even further object of the inventions disclosed herein is to provide a concrete placing and circulation system and methodology that decreases preparatory work and time and cost for placing concrete at a construction site.

### SUMMARY OF THE DISCLOSURE

A system and method for placing and circulating concrete is disclosed. The system includes a hopper for holding and circulating a concrete slurry, a pump, valves, and one or more hoses for placing concrete. The hopper includes a main body and a plurality of augers or other elements within the main body for continuously circulating the concrete slurry within the body. The hopper has an outlet with a valve, which is connected to the pump. The outflow side of the pump is connected to one or more hoses, with a valve for controlling flow from the pump to each hose. The pump conveys concrete slurry from the hopper body and through the hose(s). The system may additionally include a return conduit so that concrete slurry that has been drawn by the pump out of the hopper can be immediately returned to the hopper and recirculated rather than placed through the hoses. The hopper of the system may further include a cooling mechanism, such as a heat exchanger, to help keep the temperature of the concrete slurry from rising, thereby prolonging the dwell time of the concrete slurry.

### BRIEF DESCRIPTION OF THE FIGURES

For a fuller understanding of the nature and objects of the invention, reference should be made to the following detailed description taken in conjunction with the accompanying figures.

FIG. 1 is a diagram showing a system for placing and circulating concrete, including a hopper body.

FIG. 2 shows a side view of the hopper body of the system of FIG. 1.

FIG. 3 shows a left-side view of the hopper body of the system of FIG. 1.

FIG. 4 shows a top view of the hopper body of the system of FIG. 1.

FIG. 5 is a sectional side view of the hopper body of the system of FIG. 1 showing a feed auger and circulating elements mounted in the hopper body.

FIG. 6 shows a left-side view of the feed auger and circulating elements of FIG. 5.

FIG. 7, shows a first alternative arrangement of circulating elements in the hopper.

FIG. 8 shows a second alternative arrangement of circulating elements in the hopper.

FIG. 9 shows a third alternative arrangement of circulating elements in the hopper.

FIG. 10 shows a fourth alternative arrangement of circulating elements in the hopper.

FIG. 11 is the same sectional side view of FIG. 5 illustrating how concrete slurry flows in the hopper when the auger and circulating elements are rotated in one direction.

FIG. 12 is the same sectional side view of FIG. 5 illustrating how concrete slurry flows in the hopper when the auger and circulating elements are rotated in a direction opposite to the direction of rotation of FIG. 11.

FIG. 13A shows a side view of an auger or circulating element showing flow generation when the auger or circulating element rotates in one direction.

FIG. 13B shows the same side of the auger or circulating element of FIG. 13B showing flow generation when the auger or circulating element rotates in a direction opposite to the direction of rotation of FIG. 13A.

FIG. 14 shows the system of FIG. 1 with an alternative return conduit configuration.

FIG. 15 shows the system of FIG. 1 further comprising a heat exchanger.

FIG. 16 is a flow chart of a method for placing and circulating concrete.

### DETAILED DESCRIPTION OF THE DISCLOSURE

Although the invention will be described in terms of certain embodiments, other embodiments, including embodiments that do not provide all of the benefits and features set forth herein, are also within the scope of this disclosure. Various structural, logical, and process step changes may be made without departing from the scope of the invention.

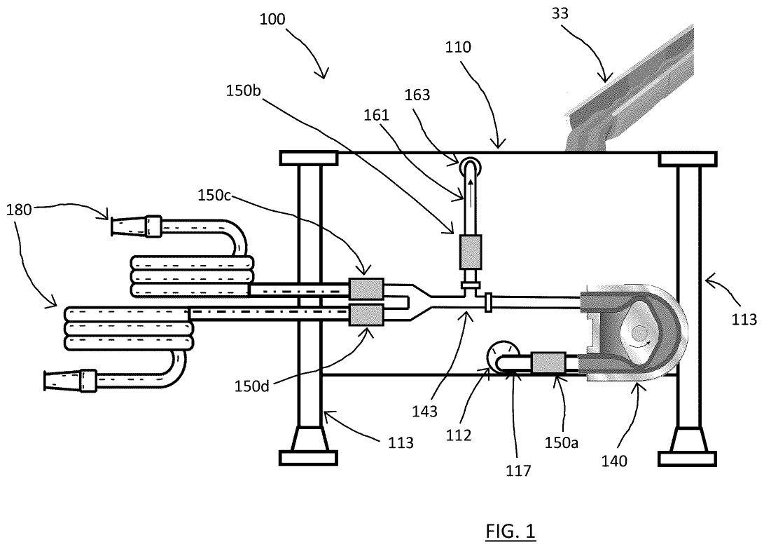

FIG. 1 is a diagram showing an embodiment of a concrete placement and circulating system 100. The system 100 may be located at a construction site, at a plant or at any other desired location. The system 100 may be free-standing on the ground, mounted upon a trailer or flatbed so that it is mobile, mounted on a platform or in a cage that can be moved about a construction site using a crane, forklift or other moving device.

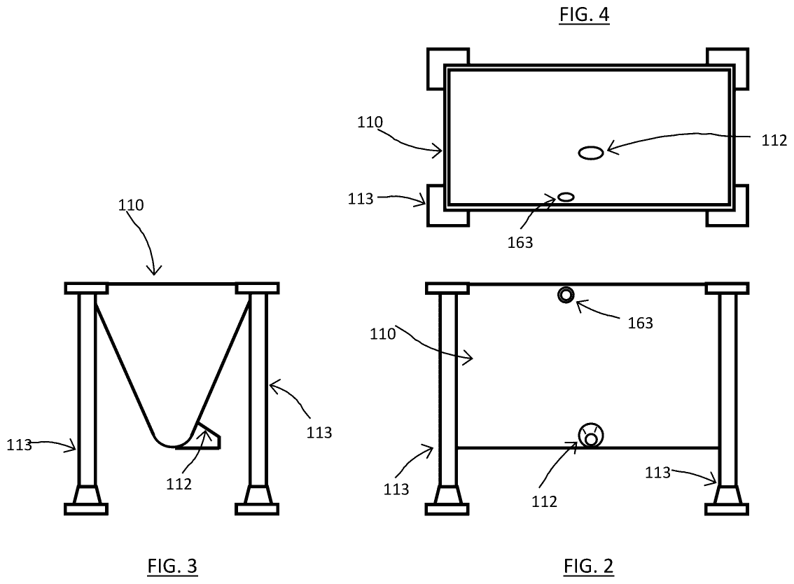

The system 100 comprises a hopper body 110, a pump 140, a plurality of valves 150 (i.e., valves 150a-d), and one or more hoses 180. The hopper body 110 has four side walls and a bottom wall and is open on its top side. As shown in FIG. 3, at least one set of opposing side walls are angled towards each other from top to bottom, to create a funnel-like shape. Both sets of opposing side walls may be so angled. The hopper body is supported by one or more bases 113. Referring to FIG. 1, in use, a mixed concrete slurry 33 is placed or otherwise supplied into hopper body 110. The hopper body 110 and the bases 113 may be constructed of metal, alloy or any other suitable material or combination thereof. The hopper body 110 may be sized as desired and, for example and without limitation, may be sized to hold two to three cubic yards of the concrete slurry 33, or any lesser or greater volume as desired.

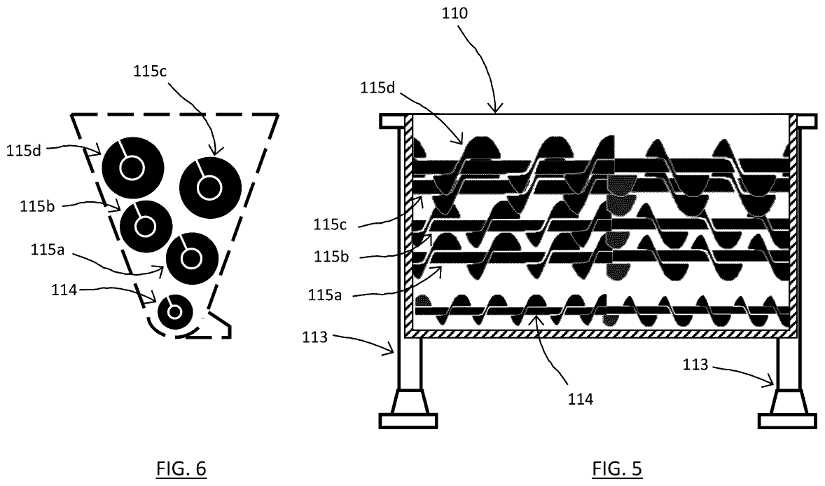

Referring to FIGS. 1-4, the hopper body 110 has an outlet 112 near the bottom of one of the hopper side walls. As shown in FIGS. 5 and 6, an auger 114 (hereinafter “feed auger”) is mounted near the bottom of the hopper body 110 and close to the outlet 112, so that when the feed auger 114 rotates it pulls the concrete slurry 33 from a higher elevation in the hopper body 110 down and towards the outlet 112, as discussed in more detail below. The outlet 112 can be of any suitable size. In the embodiment shown in FIGS. 1-4, the outlet opening is larger at the hopper body 110 side than at its opposite end, and thus reduces in size away from the hopper body 110. For example, but without limitation, the outlet may have a diameter of 8″ at the hopper body and 3″ at its opposite end.

Referring to FIG. 1, the pump 140 is connected to the outlet 112 by a feed conduit 117, which may be a rigid or flexible pipe or hose, made of any suitable material. The pump 140 operates to pull the concrete slurry 33 out of the hopper body 110 through the outlet 112 and the feed conduit 117. The valve 150a is situated between the hopper outlet 112 and the pump 140, and may be closed to prevent concrete slurry from flowing from the hopper into the pump and opened to allow such flow. In one embodiment, the valve 150a is a pinch valve, though any suitable valve may be used.

In the embodiment of FIG. 1, the pump 140 is a peristaltic pump that pushes concrete slurry through a flexible hose within the pump. The pump 140 may be one that is reversible, such that it could push concrete slurry in either direction through the flexible hose. Though not required, a peristaltic pump is preferred because it generates less heat than some other types of pumps, such as piston pumps, which in turn helps to prolong the dwell time of concrete slurry. Peristaltic pumps also may be relatively easier to clear than some other types of pumps, thereby reducing the amount of time and labor needed for using and maintaining the pumps. A peristaltic pump is also preferred for concrete slurries having high density and/or viscosity, such as HPCHPC and UHPC. However, any suitable pump may be used.

The pump 140 propels concrete slurry through an outlet of the pump and into a junction 143 leading to a return conduit 161 and the one or more hoses 180. In the embodiment of FIG. 1, the junction 143 has three outlets. The return conduit 161 is connected to one outlet and the two hoses 180 are connected to the other two outlets. The valve 150 is situated at each outlet of junction 143. The valve 150b leads to the return conduit 161, the valve 150c leads to a first of the hoses 180, and valve 150d leads to a second of the hoses 180. Each of the valves 150a-c can be open or closed independently, such that all three outlets can be open, all three outlets can be closed, or one or two outlets can be open while the other outlet(s) is closed. In one embodiment the valves 150b-d are pinch valves, though any suitable valve may be used. The valves 150a-d may be manually operated or electronically operated to open and close. Additionally, each of the valves 150a-d can be adjusted to increase or decrease the flow rate and/or pressure of concrete slurry flowing through such valve.

In one mode of operation, the valve 150c to the first of the hoses 180 is open, and the valve 150d (to the second of the hoses 180) and the valve 150b (to the return conduit 161) are closed. In this mode, the concrete slurry 33 is pumped from the hopper body 110 into the first hose 180 so that concrete expelling from the end of such hose 180 may be placed. In another mode of operation, the valves 150c and 150d leading to the first and second of the hoses 180 are open, and the valve 150b leading to the return conduit 160 is closed. In this mode, concrete slurry 33 is pumped from the hopper body 110 into both of the hoses 180 so that concrete expelling from the end of each of the hoses 180 may be placed. The valves 150c and 150d may be set so that the flow rate and/or pressure of concrete slurry in the two hoses are the same, or may be set so that the flow rate and/or pressure in one hose is different than in the other hose. This may be desired, for example, where the hoses are being used at different locations of a construction site and have differing concrete slurry placement needs. The hoses may be made of any suitable flexible material, and may be of any suitable diameter. Without limitation, the hoses may be 7 to 11 centimeters in diameter, and may be 7 to 30 meters in length.

As shown in FIGS. 5-8, the system 100 is configured so that the concrete slurry 33 within the hopper body 110 may be continuously or substantially continuously circulated. To this end, the system 100 comprises the feed auger 114 and one or a plurality of other augers 115 (each a “circulating element”). Referring to FIGS. 5 and 6, in this embodiment, the feed auger 114 is mounted close to the bottom of the hopper body 110, and each one of the circulating elements 115a-d is mounted at a different height above the feed auger 114. As shown in FIGS. 5 and 6, the circulating element 115a is situated above the feed auger 114, the circulating element 115b is situated above the circulating element 115a, the circulating element 115c is situated above the circulating element 115b, and the circulating element 115d is situated above the circulating element 115c. As used herein, “situated above” or “mounted above” with respect to a circulating element means that at least some portion of the circulating element is above the highest portion of the feed auger or another circulating element. For example, if the center of the shaft of one circulating element is higher than the center of the shaft of a second circulating element, then the first circulating element is situated above the second circulating element.

In the embodiment of FIGS. 5-6, each one of the circulating elements 115a-d is positioned so as to be offset from the position of both the feed auger 114 and each other one of the circulating elements 115a-d. Furthermore, the diameter or size of each one of the circulating elements 115a-d may increase as each is situated further away from the feed auger 114. In the embodiment of FIGS. 5 and 6, the circulating elements 115a and 115b are the same size as each other and have larger diameters than the feed auger 114, and the circulating elements 115c and 115d are the same size as each other and have larger diameters than the circulating elements 115a-b. In another embodiment, all of the circulating elements 115 are of the same size and are larger than the feed auger 114. For example, and without limitation, the feed auger 114 may have a diameter in a range of 25-35 centimeters while the circulating elements 115 have a diameter in a range of 45-60) centimeters.

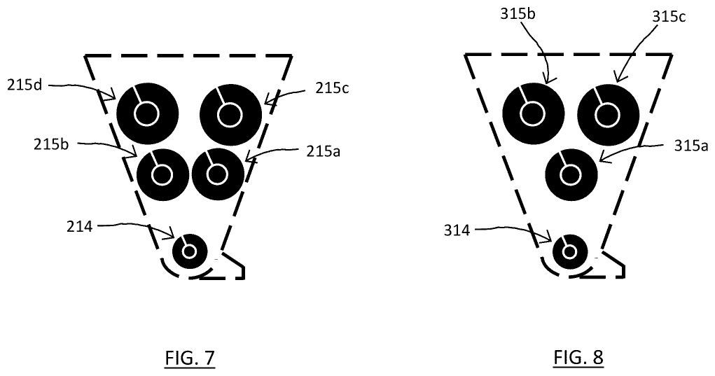

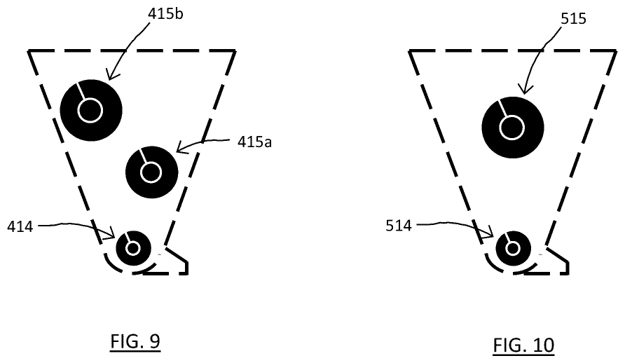

FIGS. 7-10 shows alternative embodiments of the circulating elements. In the embodiment of FIG. 7, a circulating element 215a and a circulating element 215b are mounted at a same height as each other yet above a feed auger 214, and a circulating element 215c and a circulating element 215d are mounted at the same height as each other yet above the circulating elements 215a-b. In the embodiment of FIG. 8, there are three circulating elements 315a-c. The circulating element 315a is mounted above a feed auger 314, and the circulating elements 315b and 315c are mounted at the same height as each other yet above the circulating element 315a. In the embodiment of FIG. 9, there are a circulating element 415a and a circulating element 415b. The circulating element 415a is mounted above a feed auger 414 and the circulating element 415b is mounted above the circulating element 415a. In the embodiment of FIG. 10, there is only a single circulating element 515, which is mounted above a feed auger 514. Similar to the embodiment of FIGS. 5-6, in each of the embodiments of FIGS. 7-10, the diameters or sizes of the circulating elements in the embodiments increase as they are situated further away from the feed auger. Alternatively, all circulating elements could be the same size. Although not shown in FIGS. 7-8, additional circulating elements may be included in a variety of configurations to enable the continuous circulation of the concrete slurry within the hopper body.

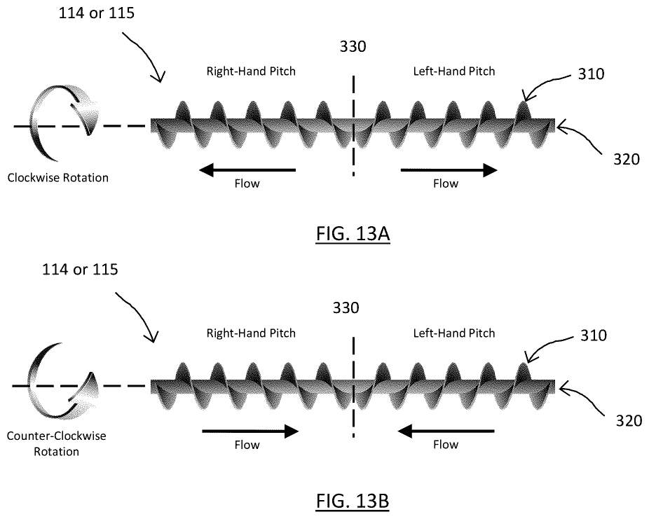

Referring to FIGS. 5-13, the feed auger and circulating elements are sized, configured and arranged so that concrete slurry 33 within the hopper body 110 can be continuously circulated within the hopper body, without interfering with the flow of the concrete slurry 33 towards the outlet 112 when desired. In the embodiment of FIGS. 5-6, for example, the circulating elements 115a-d are augers. As shown in FIGS. 13A and 13B, the augers 114 or 115 are constructed to have flighting 310 with opposite oriented pitch on either side of the longitudinal center 330 of the shaft 320 of the auger (hereinafter “dual-action” augers). To left of the shaft center 330, the flighting has a right-hand pitch, and to right of the shaft center 330, the flighting has a left-hand pitch (“Right-Left Hand Pitching”). As illustrated in FIG. 13A, due to these opposed orientations, when the shaft 320 of the auger rotates clockwise (viewed from the left-hand side of the auger), it generates flow from the center of the auger outward to either end of the auger (“Center-Outward Flow”). As illustrated in FIG. 13B, when the shaft 320 of the auger rotates in the opposite direction, i.e., counter-clockwise, it generates flow from either end of the auger inward to the center of the auger (“Inward-Center Flow”). Of course, the orientation of the flighting 310 could be reversed so that the right-hand pitch is to the right of center of the shaft and the left-hand pitch is to the left of center of the shaft (“Left-Right Hand Pitching”), so that Center-Outward Flow and Inward-Center Flow can still be achieved but by rotating the shaft counter-clockwise and clockwise, respectively. Likewise, some of the feed auger and circulating elements could all have Right-Left Hand Pitching or Left-Right Hand Pitching, or a combination where one or more have Right-Left Hand Pitching and one or more have Left-Right Hand Pitching, and then the direction of rotation for each feed auger and circulating element could be selected to achieve a desired Center-Outward or Inward-Center Flow.

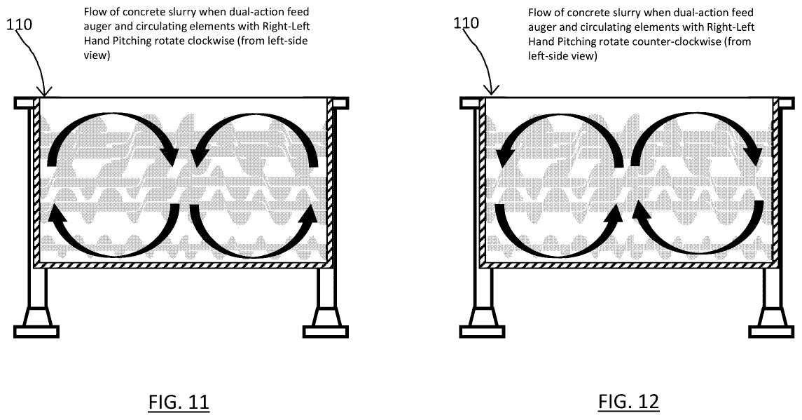

As shown in FIG. 11, when dual-action augers with Right-Left Hand Pitching are used and rotated clockwise, the feed auger 114 propels the concrete slurry out towards the sides of the hopper body 110 whereupon it travels upward along the sides. The circulating elements mounted above the feed auger 114 contribute to the outward/upward flow. When the concrete slurry 33 reaches the top of the hopper body 110, gravity urges it to fall. As a consequence, the concrete slurry 33 flows towards the top center of the hopper, down towards the bottom of the hopper, and then out towards the opposite side walls of the hopper, then up towards the top of the hopper, then back towards the center of the hopper, and then back down towards the bottom of the hopper and so on (the “Center-Down Circulation Mode”). The Center-Down Circulation Mode keeps the concrete slurry 33 in circulation and pushes the concrete slurry 33 towards the outlet 112.

As shown in FIG. 8, the opposite occurs when the augers rotate counterclockwise. In this state, the concrete slurry 33 flows from the bottom center of the hopper, up towards the top of the hopper, and then then out towards the opposite side walls of the hopper, then down towards the bottom of the hopper, then back towards the center of the hopper, and then back up towards the top of the hopper and so on (the “Center-Up Circulation Mode”). The Center-Up Circulation Mode action keeps the concrete slurry 33 in circulation and pushes the concrete slurry 33 away from outlet 112.

In either the Center-Down or Center-Up Circulation Modes, in some cases it may be desirable for the feed auger and each of the circulating elements to rotate in the same direction, and in some cases it may be desirable for the feed auger to rotate in one direction and for some or all of the circulating elements to rotate in the opposite direction. As one example, but without limitation, in the embodiment illustrated in FIG. 9, the feed auger 414 and the circulating element 415a can be rotated clockwise to generate Center-Outward Flow and the circulating element 415b can be rotated counterclockwise to generate Inward-Center Flow (or the circulating element 415b can have Left-Right Hand Pitching and rotate clockwise, like the feed auger 414 and the circulating element 415a, to generate Inward-Center Flow). In this circumstance, when the concrete slurry travels upward along the sides of the hopper body 110 and nears the circulating element 415b, the circulating element 415b can help to convey the concrete slurry towards the center of the hopper. The Circulation Modes, flighting orientations, rotation directions, rotation speeds and other variables can be mixed and matched as desired.

Varying the sizes and locations of the circulating elements 115, as well as the speeds and directions of rotation of the circulating elements 115, enables an operator to achieve a desired speed and/or degree of circulation of the concrete slurry 33, which may vary with the type of concrete and/or the properties thereof. The feed auger 114 and circulating elements 115 can be operated at any desired speed, including for example any speed within the range of 1-60 RPM. For UHPC, it is sometimes desirable to achieve a laminar flow of the concrete slurry 33 and to avoid turbulent flow. One of the objectives of using larger augers 115 towards the top of the hopper body 110 is that it allows the auger(s) to rotate at slower speeds while still keeping the concrete slurry in laminar flow, thus helping to prevent the introduction of heat and turbulence that might otherwise be generated by friction between the circulating elements and the concrete slurry. For example, the larger circulating elements 115 may be operated at speeds of 1-30 RPM (with each element operating at the same speed, or each at a different speed, or a combination thereof) while the smaller feed auger 114 is operated at a speed higher than any of the circulating elements and, for example, at speeds of 20-50 RPM. While the feed auger 114 and the circulating elements 115 are shown herein as augers, any suitable propeller, blade, paddle, auger, conveyor, screw or other propulsion, blending or mixing mechanism for causing concrete slurry within the hopper body 110 to be moved and continuously circulated or substantially circulated may be used. Keeping the concrete slurry in a continuous state of circulation, and particularly laminar flow, while also minimizing the introduction of heat, helps to increase the dwell time of the concrete slurry.

During operation, if the level of the concrete slurry 33 in the hopper body 110 drops below the level of one or more of the circulating elements 115, any one of such circulating elements could be slowed down or turned off. In either case, it can be helpful to prevent the concrete slurry 33 adhering to the surfaces of the circulating element from hardening. To this end, a fluid or other agent for inhibiting hardening can be sprayed onto the circulating element.

The system 100 is also configured so that the concrete slurry 33 pumped out of the hopper body 110 may be recirculated back into the hopper body 110. As shown in FIG. 1, the system 100 comprises the return conduit 161, having one end connected to an outlet of junction 143, with the valve 150b to open or close flow from the junction 143 to the return conduit 161. As shown in FIGS. 1 and 2, the other end of the return conduit 161 is connected to the hopper body 110, at an opening 163 in and near the top of a side wall of the hopper body 110. In one state of operation, the valves 150c and 150d to the one or more hoses 180) are closed while the valve 150b to the return conduit 161 is open. As the pump 140 draws the concrete slurry 33 from the hopper body 110, it then pushes the slurry through the return conduit 161 back into the hopper body 110 and so on (hereinafter “Primary Recirculation”). Together with the action of the feed auger 114 and the circulating elements 115, this Primary Recirculation mode of operation may be used to circulate and extend the dwell time of the concrete slurry 33 within the hopper body 110 during periods of time when concrete slurry is not being placed (through the hoses 180). The concrete slurry 33 may alternatively be recirculated into the hopper body 110 in this manner to create a circulating flow of the concrete slurry 33 within the hopper body 110 without the use of one or both of the feed auger 114 and the circulating elements 115. The Primary Recirculation mode of operation may be used simply to prime the pump 140 shortly prior to opening flow of the concrete slurry 33 to one or more of the hoses 180, or at any time to maintain or extend dwell time when the concrete slurry 33 is in the hopper but not desired to be placed through the hoses 180.

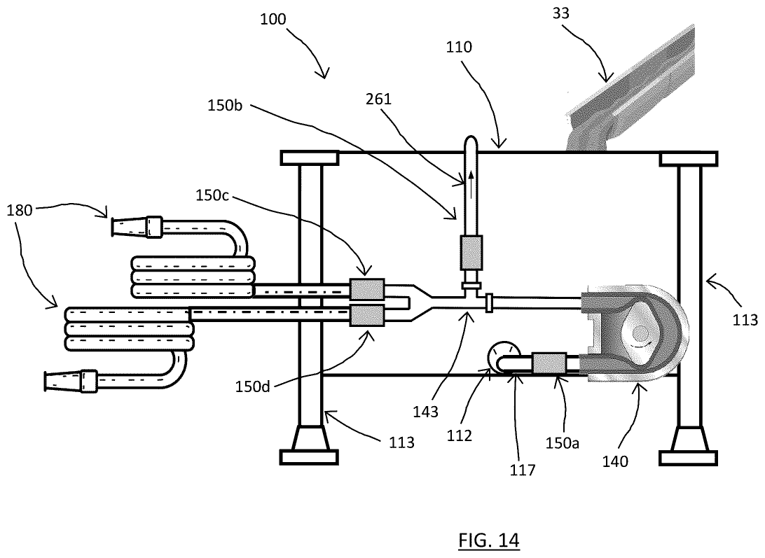

FIG. 14 shows an alternative embodiment of a return conduit 261. In this embodiment, the return conduit 261 is configured so that, rather than being connected to an upper wall of the hopper body 110, it extends over the top of the hopper body 110 so that the concrete slurry 33 exiting the return conduit 261 flows into the hopper body 110 through the hopper body's open top side. The return conduit 261 otherwise operates within the system 100 as described above for recirculating the concrete slurry 33.

In the Primary Recirculation mode of operation described above, the concrete slurry 33 is recirculated through the return conduit 161 (or 261) when the valve to the return conduit 161 (or 261) is open and the valves 150c and 150d to the hoses 180 are closed. In another mode of operation, the concrete slurry 33 may be recirculated when the reverse is true, i.e., when one or more of the valves 150c-d to the hoses 180 are open and the valve 150b to the return conduit is closed (“Hose Recirculation”). In this mode, either the pump 140 had been delivering the concrete slurry 33 to one or more of the hoses 180 for placement, or pumping the concrete slurry 33 to the hoses 180 is about to begin. If it is desired to continue to pump the concrete slurry 33 through the hoses 180 but not place, or discontinue placing, the concrete slurry 33, the ends of the open hoses 180 can be directed into the open, top side of the hopper body 110. Optionally, to prevent the concrete slurry 33 from flowing out of the ends of the hoses 180 as they are being moved to the hopper body 110, the pump 140 could be paused, or even reversed for a moment and then paused, and then resumed when the ends of the hoses 180 are in place at the hopper body 110. As the pump 140 draws the concrete slurry 33 from the hopper body 110, it then pushes the slurry through the open hoses 180 and back into the hopper body 110 and so on. Additionally, in this Hose Recirculation mode of operation, rather than closing the valve 150b to the return conduit 161, it could be kept fully or partially open for the concrete slurry 33 to flow through the return conduit 161 at the same time the slurry is flowing through the open hoses 180.

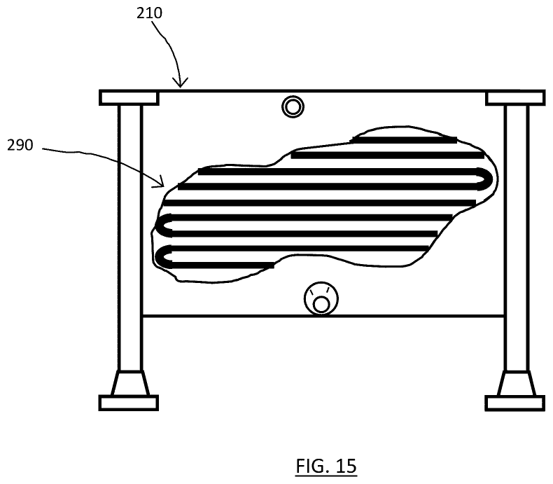

FIG. 15 shows an alternative embodiment of a hopper body 210. In this embodiment, the side walls of the hopper body 210, and optionally also the end walls and/or bottom wall, comprise a double-wall construction. A heat exchanger 290 is contained within the hollow areas of the side walls, and/or in the hollow areas of the end walls, and/or in the hollow areas of the bottom wall of the hopper body 210. Thus, the heat exchanger 290 may be in some of the walls or all of the walls of the hopper body 210. The heat exchanger 290 is used to help remove heat from the concrete slurry 33 to prolong the dwell time of the concrete slurry. In the embodiment shown in FIG. 15, the heat exchanger 290 comprises a series of pipes through which cold water, glycol or any other suitable fluid is circulated to absorb heat from the concrete slurry 33. However, any suitable heat exchanger may be used.

Some concrete mixes, and in particular UHPC, may contain fiber reinforcements, such as steel fibers, which help to improve the tensile and flexural strength of the concrete when it hardens. Certain mixes of Steelike® UHPC supplied by Kulish Design Co., LLC, for example, contain steel fibers that are relatively rigid and up to about 1.3 centimeters in length. Compared to other ingredients in concrete, such fiber reinforcements and, in particular, steel fibers, can be abrasive and/or sharp. Over time, these fibers and other abrasive materials can erode or even ruin pumps, conduits and hoses used to place the concrete. In the system 100 described herein, one advantage of using the pump 140 that is a peristaltic pump is that it is less prone to be harmed by fiber reinforcements. Another advantage is that the pump 140 and the valves 150 can be set so that the pressures and flow rates of the concrete slurry 33 keep the fiber reinforcements entrained in the slurry and oriented generally in the direction of flow of the slurry, thus minimizing any harm to the pump, valves, conduits or hoses. As an additional precaution, the interior surfaces of some or all of the pump, valves, conduits or hoses could be coated with Teflon or other materials useful to prevent or decrease potential wear and tear from fiber reinforcements.

Any suitable power supply and motors can be used for operating the system 100. For example, without limitation, a gas or diesel motor may be used to run a hydraulic circulating pump which, in turn, is used to operate the valves and powers one or more hydraulic motors for operating the pump, feed auger and circulating elements. A control panel or other interface may be provided for the operator to turn the motors, pumps, feed auger, circulating elements on and off, to open and close the valves, and to adjust settings thereof for achieving desired speeds, flow directions, pressures, flow rates, etc.

In addition to the many advantages described above and that may also be apparent from or inherent in the concrete placement and recirculation system 100 described herein, such system can be particularly useful during bridge repairs for placing UHPC below bridge decks, for example, to fill beam joints or as an overlay on existing concrete elements. Traditionally, forms are created around such beams or other elements for placing the UHPC and holding it in place while it is hardening. To enable the UHPC to be placed, openings are cut through the bridge deck. The UHPC is placed through the opening into the forms, and then the deck is repaired by filling the opening back in with concrete, which also requires a form and sometimes also requires additional rebar to be first tied in. This methodology is time consuming and expensive, and disruptive to the bridge's existing deck including shutting down traffic across the bridge or one or more of its lanes. Using the system 100 described herein, the hoses 180 can be used to place the concrete slurry 33 into forms from below the bridge deck and thus without cutting openings through the deck. After the form is put into place, concrete slurry 33 can be pumped through the hoses 180 into the form through an open top side of the form, or through openings created in a side or bottom of the form. This eliminates the need to cut openings through and repair the bridge deck and also eliminates the need to stop or reduce traffic across the bridge.

### Operation

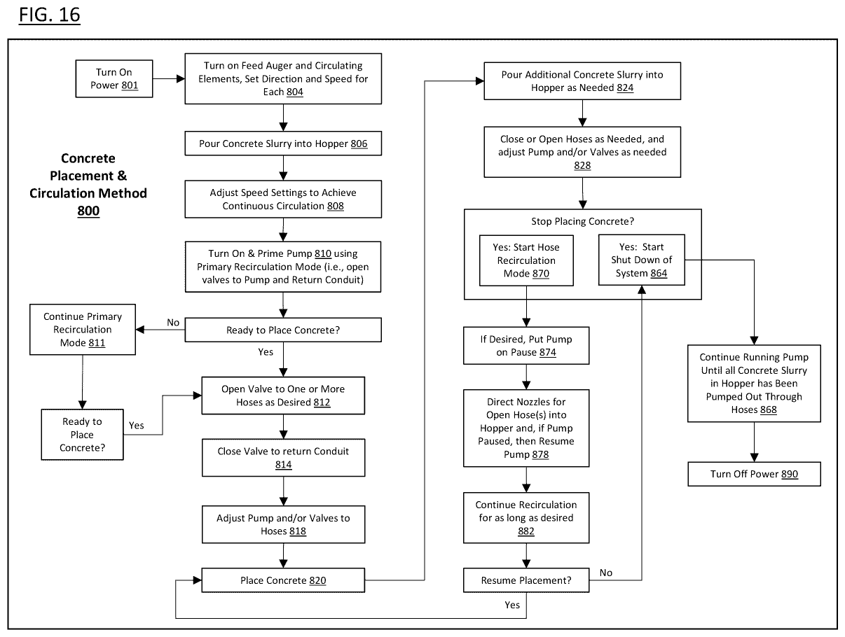

FIG. 16 is a flow chart showing an embodiment of a method 800 of concrete placement and circulation. Power to a concrete placement system is turned on 801. If the hopper body includes a heat exchanger, then it may be turned on as well. A feed auger and one or more circulating elements in a hopper body are turned on, and the direction of rotation and speed for each are set 804. Concrete slurry is placed into the hopper body 806. If needed, the speed and direction settings for the feed auger and circulating elements are adjusted 808 to achieve continuous circulation of the concrete slurry in the hopper body. The pump is turned on and primed 810 using the Primary Recirculation Mode. If the operator is not yet ready to begin placement of concrete through the hoses, the Primary Recirculation Mode may be continued 811. When the operator is ready to begin placement of concrete through one or more hoses, valves to one or more hoses are opened 812 and the valve to the return conduit is closed 814. If needed, one or more of the pump speed and hose valves are adjusted 818 to achieve a desired flow rate of concrete slurry through the hose(s). Using the hose(s), concrete is then placed 820. Placement of concrete continues for so long as desired. Additional concrete slurry is added to the hopper body as needed 824, and hoses may be opened or closed and adjusted 828 as needed or desired.

When placement of concrete is no longer desired, the system can be turned off or otherwise shut down 864, 890. Prior to shutting down the system, the concrete slurry remaining in the hopper body can be pumped out through the hoses 860. As the hopper body empties of concrete slurry, water can be added to the hopper body so that the pump can continue to operate until all of the concrete slurry is evacuated from both the hopper body and the hoses. Additionally, if desired, the pump, conduit and hoses can further be cleaned of concrete slurry prior to shut down by pumping clean out balls, such as sponge balls made and/or sold by RubberMill, Inc., through the system.

If it is desired to cease placement of concrete only temporarily, then the Hose Recirculation Mode can be used 870 to circulate concrete slurry. If desired, the pump is paused or may even be reversed momentarily and then paused 874, to prevent concrete slurry from flowing out of the ends of the hoses. The ends of the open hoses are brought to and directed into the hopper body through the hopper body's open top side 878. Operation of the pump is resumed, whereupon concrete slurry is pumped from the hopper body and through the open hoses back into the hopper body. This Hose Recirculation Mode is continued for as long as desired 882. When it is desired to resume placing concrete, then placement is so resumed 812 (and the pump may be paused, or even reversed for a moment and then paused, as the hose ends are removed from the hopper and brought to the placement location), and various steps described above are repeated. Alternatively, rather than resume placement of concrete, the system can be turned off or otherwise shut down 864, 890 as described above.

While the method of placing and circulating concrete 800 is described above with steps in a particular order, steps may be performed in a different order and/or different combinations of steps may be performed and/or fewer or additional steps may be performed.

It is intended that the foregoing detailed description be regarded as illustrative rather than limiting and that it is understood that the following claims including all equivalents are intended to define the scope of the invention.

1. A system for placing concrete comprising:
a hopper body that holds concrete slurry;
a feed auger mounted in the hopper body;
at least one circulating element mounted in the hopper body;
a pump in fluid communication with the hopper body to draw the concrete slurry from the hopper body; and
a junction in fluid communication with the pump and the hopper body, wherein in a recirculation mode of operation, at least a portion of the concrete slurry drawn by the pump is recirculated into the hopper body through the junction.

2. The system of claim 1, wherein the feed auger is a dual-action auger.

3. The system of claim 2, wherein the at least one circulating element is a dual-action auger.

4. The system of claim 1 further comprising:
two or more circulating elements mounted in the hopper body.

5. The system of claim 4, wherein each circulating element is mounted at a height above the feed auger.

6. The system of claim 4, wherein each circulating element is of a different size than the size of the feed auger.

7. The system of claim 5, wherein each circulating element is mounted at a height above the feed auger that is different from the height at which each other circulating element is mounted.

8. The system of claim 4, wherein a speed of each circulating element can be at a same speed or a different speed as each other circulating element.

9. The system of claim 8, wherein a direction of movement of a circulating element can be reversed, and further wherein a direction of movement of a circulating element can be in a same direction or a different direction as each other circulating element.

10. The system of claim 1 further comprising:
the pump having a pump inlet and a pump outlet, wherein the pump inlet is in fluid communication with the hopper body; and
the junction having a junction inlet and two or more junction outlets, wherein the junction inlet is in fluid communication with the pump outlet.

11. The system of claim 10 further comprising:
a conduit having a conduit inlet and a conduit outlet, wherein the conduit inlet is in fluid communication with one of the two or more junction outlets and the conduit outlet is situated so that when the at least a portion of the concrete slurry drawn by the pump travels through the conduit, the at least a portion of the concrete slurry is returned into the hopper body.

12. The system of claim 10, wherein the junction has three junction outlets.

13. The system of claim 11, wherein a valve is in line with each junction outlet operable to open or close flow out of such junction outlet independently of opening and closing each other outlet of the junction outlets.

14. The system of claim 10, wherein the pump is reversable reversible.

15. The system of claim 1, wherein the hopper body further comprises a heat exchanger.

16. A system for placing concrete comprising:
a hopper body that holds concrete slurry, the hopper body comprising a hopper outlet;
a feed auger mounted in the hopper body;
two or more circulating elements mounted in the hopper body;
a pump that draws the concrete slurry from the hopper body, the pump having a pump inlet and a pump outlet, wherein the pump inlet is in fluid communication with the hopper outlet;
a junction having a junction inlet and two or more junction outlets, wherein the junction inlet is in fluid communication with the pump outlet; and
a conduit having a conduit inlet and a conduit outlet, wherein the conduit inlet is in fluid communication with one of the two or more junction outlets and the conduit outlet is situated so that when the concrete slurry travels through the conduit, the concrete slurry passes into the hopper body.

17. The system of claim 16, wherein the feed auger and at least one of the circulating elements is a dual-action auger.

18. A method for placing and circulating concrete comprising:
adding concrete slurry into a hopper body;
continuously circulating the concrete slurry in the hopper body; and
drawing concrete slurry from the hopper body and propelling the concrete slurry through one or more hoses.

19. The method of claim 18 further comprising:
drawing concrete slurry from the hopper body and conveying the concrete slurry back into the hopper body through a conduit or through the one or more hoses.

20. The method of claim 18 further comprising:
withdrawing heat from the concrete slurry within the hopper body.
